(19) United States
(12) Patent Application Publication
(10) Pub. No.: US 2014/0012430 A1
(43) Pub. Date: Jan. 9, 2014

(54) METHOD FOR OPERATING A SYSTEM FOR RECOVERING ENERGY FROM EXHAUST GAS OF A VEHICLE

(71) Applicants: Udo SCHULZ, Vaihingen/Enz (DE); Florian SCHMITT, Bretten-Sprantal (DE)

(72) Inventors: Udo SCHULZ, Vaihingen/Enz (DE); Florian SCHMITT, Bretten-Sprantal (DE)

(73) Assignee: ROBERT BOSCH GMBH, Stuttgart (DE)

(21) Appl. No.: 13/935,029

(22) Filed: Jul. 3, 2013

(30) Foreign Application Priority Data
Jul. 4, 2012 (DE) 10 2012 211 599.4

(51) Int. Cl. G06F 17/00

(52) U.S. Cl. CPC G06F 17/00
USPC 701/1

(57) ABSTRACT

A method and device for planning a recovery of energy from an exhaust gas of a vehicle is provided. The method and device include: estimating an operating behavior of the vehicle on a route to be traveled by the vehicle; and planning the recovery of energy from the exhaust gas of the vehicle based on a likelihood that the estimated operating behavior of the vehicle corresponds to an operating behavior that is suitable for the recovery.

### CROSS-REFERENCE TO APPLICATION

This patent application claims priority to and incorporates by reference thereto, in its entirety, German Patent Application Serial No. 102012211599.4, having filing date Jul. 4, 2012.

### FIELD

The present invention generally relates to combustion engines, and specifically combustion engines that are equipped with a system for recovering energy from exhaust gas of the combustion engine. The present invention relates to methods for operating a system for recovering energy from exhaust gas of a vehicle.

### BACKGROUND INFORMATION

A system for recovering energy from the exhaust gas of a combustion engine that utilizes waste heat from the exhaust gas is described in German patent application DE 10 2006 057 247 A1. A heat exchanger, which transfers heat from the exhaust gas to a working medium flowing in a heat circuit, is installed in an exhaust tract of the combustion engine for this purpose. The working medium in the heat circuit drives a turbine or a piston machine, whose rotational energy can be converted into electrical energy, for example, so that it can be utilized in the onboard electrical system of a vehicle. Such a system is also known as “waste heat recovery” system (“WHR” system).

### SUMMARY

According to the present invention, a method is provided for planning the recovery of energy from exhaust gas of a vehicle, and a control device for implementing the method, as well as a vehicle including the control device.

According to an example embodiment of the present invention, a method for planning the recovery of energy from exhaust gas of a vehicle includes the following steps:
estimating an operating behavior of the vehicle on a route to be traveled by the vehicle; and
planning the recovery of energy from exhaust gas of the vehicle based on a likelihood that the estimated operating behavior of the vehicle corresponds to an operating behavior that is suitable for the recovery.

The example method is based on the idea that an effective utilization of the WHR system depends on the energy content of the exhaust gas expelled by the vehicle, since a successful recovery of energy requires that the exhaust gas must first overcome the operational energy requirement of the WHR system itself, which, for example, is predefined by the phase transition of the utilized working medium. Using the example method, one can detect whether the utilization of the WHR system while traveling with the vehicle on a certain route section or within a time period is useful, based on an expected, and thus estimated, operating behavior of the vehicle, and to plan the operation of the WHR system accordingly. This improves the efficiency of the vehicle since the energy losses of the vehicle are reduced.

In a further example embodiment, the operating behavior suitable for the recovery of energy from the exhaust gas of the vehicle causes a state of the vehicle which must satisfy at least one predefined condition for the recovery of energy from the exhaust gas of the vehicle. The further example embodiment is based on the reasoning that the operating behavior of the vehicle, and thus the use of the WHR system in a vehicle, is best able to be detected with the aid of certain operating points of the vehicle that are a function of the speed or other load states. In a further embodiment, these operating points are able to be analyzed in time-dependent manner, so that a time period for operating the WHR system is already known before an operating point of the vehicle which is suitable for utilizing the WHR system is entered.

In a further example embodiment, at least one predefined condition depends on a predefined thermodynamic energy that the exhaust gas must have. This further development is based on the condition that the energy of the exhaust gas depends considerably on a load moment of the combustion engine of the vehicle. The higher this load moment, the hotter the exhaust gas, and the higher the mass flow of the exhaust gas and thus the energy flow. This being the case, for example, the condition for the state to be satisfied by the vehicle in order to recover energy from the exhaust gas of the vehicle is able to be made directly dependent upon this thermodynamic energy of the exhaust gas, or indirectly, via the load moment.

In an example embodiment, the method includes the step of planning a transfer of a system for recovering energy from the exhaust gas of the vehicle into an operative state, at a time before the estimated operating behavior corresponds to the suitable operating behavior, so that the system is ready for operation at the instant at which the estimated operating behavior corresponds to the suitable operating behavior. This example embodiment is based on the notion that the WHR system must possibly first be transferred into an operative state prior to use, which requires a certain period of time, however. In order to recover a maximum of energy from the exhaust gas of the vehicle, the WHR system should therefore be transferred into the operative state already prior to the instant at which the vehicle exhibits an operating behavior that lends itself to the recovery of energy from the exhaust gas. This further increases the efficiency of the vehicle.

In an example embodiment, the transfer of the system includes measures to overcome thermal and/or mechanical inertia of the system. Such measures, for example, could include purging condensate toward the condenser of the WHR system, using freshly generated steam, so that the turbine of the WHR system is immediately ready for operation.

In an example embodiment, the likelihood that the estimated operating behavior corresponds to the suitable operating behavior includes a likelihood whether the suitable operating behavior may be forced with the aid of auxiliary units in the vehicle. These auxiliary units may be any type of auxiliary unit that has an effect on the operating behavior of the vehicle. The units are limited neither to an active influence, such as a vehicle battery, nor to a passive influence, such as an electrical consumer. For example, control elements of the combustion engine itself may be used as auxiliary units, so that more exhaust-gas energy for the WHR system is provided by briefly worsening the combustion engine efficiency. As control element, a camshaft adjustment element may influence the injection of fuel mixtures into the combustion engine, a spark plug actuation can influence the combustion, or the gear shift may affect the load torque acting on the combustion engine in order to increase the efficiency of the combustion engine. In hybrid drive train concepts featuring variable moment distribution to a combustion engine and an electric motor, for example, it may be checked whether the estimated operating behavior is able to be adapted to the suitable operating behavior by briefly increasing the portion of the combustion engine and a corresponding lowering of the portion of the electric motor.

In an example embodiment, the likelihood that the estimated operating behavior corresponds to the suitable operating behavior includes a likelihood whether the suitable operating behavior is able to be adapted to the estimated operating behavior with the aid of auxiliary units in the vehicle. This example embodiment is based on the notion that as a rule, the WHR system in the vehicle is meant to replace an electrical energy source. Among other things, the operating behavior suitable for an operation of the WHR system thus is dependent upon whether the WHR system is able to supply all electrical energy consumers, e.g., in an onboard electrical system of the vehicle, with electrical energy during the estimated operating behavior of the vehicle. If it turns out within the scope of the example embodiment that it is impossible to supply all electrical energy consumers via the WHR system in the estimated operating behavior of the vehicle, it may be checked, for instance, whether the residual energy is able to be actively provided from an auxiliary energy source, or whether the load is able to be reduced by manipulating a few electrical consumers, such as heating systems or climate-control systems. In an example embodiment, alternative or in addition, the electric load may also be manipulated or influenced, for instance by briefly reducing the charge of electrical energy stores in the vehicle, such as by a brief charge transfer of electrical energy stores into the affected onboard electrical system, e.g., in the case of 12V-48V onboard electrical system topologies which are connected via DC/DC converters.

In an example embodiment, the likelihood whether the suitable operating behavior is able to be forced with the aid of auxiliary units in the vehicle includes a likelihood whether a temperature of an exhaust gas of the vehicle is able to be increased using the auxiliary units. As described herein, this can be done by manipulating the load moment of the combustion engine.

The example embodiment includes a step of prohibiting the recovery of energy from the exhaust gas of the vehicle if the likelihood that the estimated operating behavior corresponds to the suitable operating behavior drops below a predefined threshold value. This prevents the WHR system from being started up unnecessarily.

The example embodiment includes a step of reading out the route to be traveled from a navigation system, and estimating the operating behavior of the vehicle on the basis of information about the route to be traveled provided by the navigation device. For example, the information provided by the navigation device may come from environmental or traffic data, as they are distributed via the traffic message channel service, for example. For instance, given a foreseeable traffic jam on a road on which the vehicle is traveling, the recovery of energy from the exhaust gas of the vehicle requiring a free-revving operation of the combustion engine of the vehicle may be avoided. It is also possible to query the navigation device about altitude data, climate data or any other data of the travel route that is supplied by the navigation device.

The example embodiment includes the steps of writing a trip log based on a route traveled by the vehicle prior to driving the travel route, and estimating the operating behavior of the vehicle on the route to be traveled by the vehicle based on the written trip log. For example, using the trip log, load data of the combustion engine of the vehicle as a function of the route are able to be recorded and used for planning the energy recovery from the exhaust gas of the vehicle. If it turns out based on a certain driving behavior of the driver, e.g., because he is traveling back and forth between his home and his place of work on a daily basis, that a certain load state is invariably reached after a certain number of driven kilometers, for example, because the driver has to stop at a traffic light, then this may be used to effect for planning the energy recovery from the exhaust gas of the vehicle.

The example embodiment includes the step of estimating the operating behavior of the vehicle based on a near-field sensor mounted on the vehicle. With the aid of the near-field sensor, obstacles that occur directly in front of the vehicle and exclude the recovery of energy from the exhaust gas of the vehicle, and external states suitable for the vehicle diagnosis are able to be detected and utilized to plan the vehicle diagnosis. For example, a near-field sensor developed as a camera may assume an imminent acceleration based on a city limit exit sign, or it may assume imminent braking based on a slow-moving vehicle. The near-field sensor can also be used to retroactively block route sections that were already enabled for the recovery of energy from the exhaust gas of the vehicle, if the near-field sensor detects circumstances that would hamper the recovery of energy from the exhaust gas of the vehicle, such as a tractor on the road traveling ahead of the vehicle at low speed.

The example embodiment includes the steps of detecting a behavior of a driver of the vehicle, and estimating the operating behavior of the vehicle based on the behavior of the vehicle driver. For example, it is detectable whether a driver begins driving at a relatively high torque or brakes heavily over relatively short distances. In connection with the collected information mentioned earlier, it will then be possible to also plan a suitable vehicle diagnosis, for example just before a traffic light on the road, because it can be expected that the driver will brake strongly in front of the traffic light as well, or accelerate considerably after the traffic light.

The example embodiment includes a step of planning a discharge of an electrical energy store connected to a system for recovering energy from the exhaust gas of the vehicle, before the system for the recovery of energy from the exhaust gas of the vehicle is transferred into an operative state. The method is based on the understanding that the electrical energy supplied by the WHR system may be too high to be used by the vehicle in its entirety. The reason for this is that it is not always possible to ensure suitable operating scenarios for the consumption of the provided electrical energy, in which the vehicle actually has enough electrical consumers to receive the supplied electrical energy. However, before this excess electrical energy is lost, the further refinement proposes that in a phase prior to the startup of the WHR system, the electrical consumers be supplied not from the generator of the vehicle but from the electric energy store, and that the electrical energy generated by the WHR system then be stored in the electrical energy store. This makes it possible to further increase the efficiency of the vehicle.

The example embodiment provides a control device which is set up to implement one of the example embodiments.

In an example embodiment, the control device includes a memory and a processor. A described example method embodiment is stored in the memory in the form of a computer program, and the processor is provided to implement the method when the computer program is loaded from the memory into the processor.

In an example embodiment, a vehicle is provided which includes the control device.

### BRIEF DESCRIPTION OF THE DRAWINGS

FIG. 1 shows a schematic representation of a vehicle traveling on a road.

FIG. 2 shows a schematic representation of an exemplary waste heat recovery system, abbreviated as WHR system.

FIG. 3 shows an example plan regarding use of the WHR system from FIG. 2.

FIG. 4 shows an expansion of the plan from FIG. 3 for the use of the WHR system from FIG. 2.

### DETAILED DESCRIPTION OF EXAMPLE EMBODIMENTS

Elements having the same or a comparable function have been provided with the same reference numerals in the figures and are described only once.

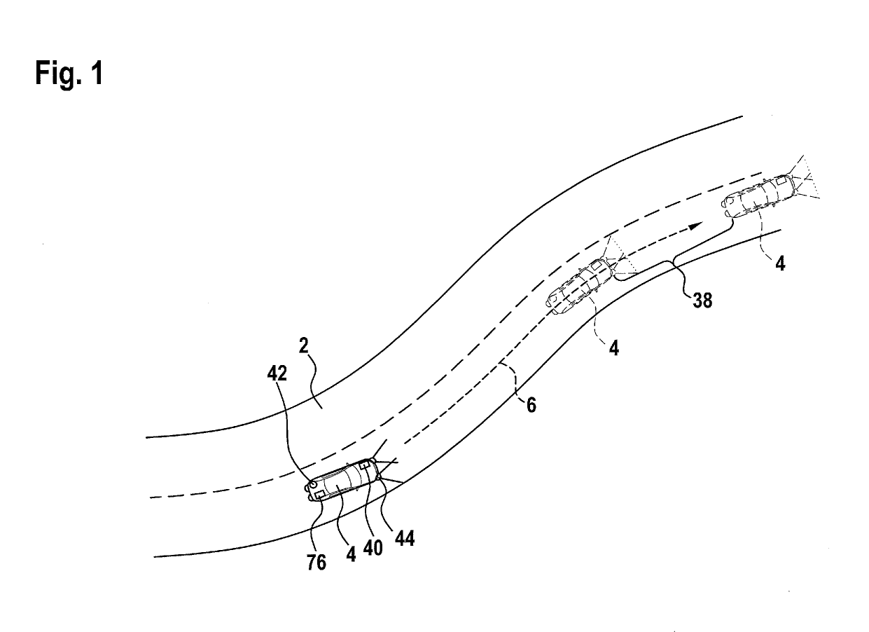

Reference is made to FIG. 1, which provides a schematic representation of a vehicle 4 traveling on a road 2.

Vehicle 4 is moving on a road 2 along a route 6. At an assumed first instant, vehicle 4 is at a location on road 2 at which vehicle 4 is shown by solid lines in FIG. 1. Using dotted lines, vehicle 4 is furthermore plotted in still another, second and third, location in FIG. 1, where it is expected to be located at a second and third instant, from the perspective of the first instant.

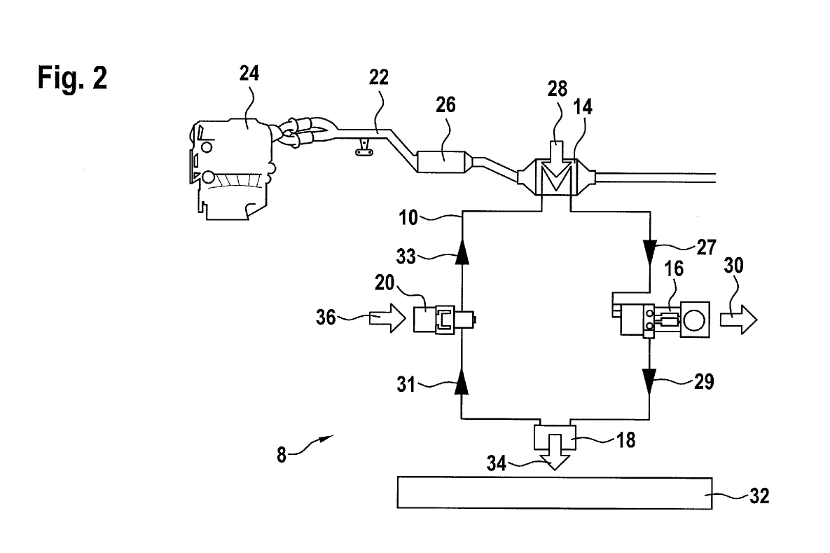

Reference is made to FIG. 2, which provides a schematic representation of an exemplary waste heat recovery system 8, abbreviated as WHR system 8.

The WHR system includes a line circuit 10, in which a working medium still to be described is circulating. At least one heat exchanger 14, an expansion machine 16, a condenser 18, and a feed pump 20 are situated within line circuit 10.

Furthermore, an exhaust gas tract 22 of a combustion engine 24, which combusts fuel in order to generate mechanical energy for driving a vehicle, for example, is routed through heat exchanger 14. The exhaust gases produced in the process are expelled via exhaust gas tract 22, inside which an exhaust catalyst 26 may be situated.

Thermal energy 28 from the exhaust gas is emitted to the working medium provided in heat exchanger 14 such that the working medium in heat exchanger 14 is able to be evaporated and overheated.

Heat exchanger 14 of line circuit 10 is connected to expansion machine 16, which may be developed as turbine or piston machine. Evaporated working medium 27 thus flows to expansion machine 16 and drives it. Expansion machine 16 has a driven shaft (not shown further), via which expansion machine 16 is connected to a load (not shown in detail). In this way mechanical energy 30 is able to be output to the load, which, for instance, may be an electric generator, a pump or the like. The driving of expansion machine 16 relaxes evaporated working medium 27.

After flowing through expansion machine 16, relaxed working medium 29 is routed to condenser 18, via which relaxed working medium 29 is able to output thermal energy 34 to a cooling device 32. This cooling device 32 may be a cooling circuit in combustion engine 24, for instance.

Cooled working medium 31 is routed to feed pump 20, which brings cooled working medium 31 to a pressure level for the evaporation in heat exchanger 14 through the supply of external energy 36.

Next, thermal energy 28 from the exhaust gas of combustion engine 24 is once again dissipated to compressed working medium 33 via heat exchanger 14, so that a closed circuit results.

As a rule, mechanical energy 30 is utilized by being converted into electrical energy via a generator, which is not shown further here. For example, the generator may be connected to an onboard electrical system (not shown) in vehicle 4, instead of an alternator driven by combustion engine 24, so that a reduced load results for combustion engine 24 and less fuel is consumed as a consequence. A direct mechanical utilization, in which mechanical energy is coupled directly onto the drive train, is possible as well.

However, to be able to use WHR system 8, the exhaust gas from combustion engine 24 must have a minimum thermal energy 28. It can be gathered from FIG. 2, for instance, that WHR system 8 has to be supplied with external energy 36 in order to obtain mechanical energy 30 from the exhaust gas of combustion engine 24 flowing through exhaust gas tract 22. However, this also means that if thermal energy 28 transferred from the exhaust gas to the working medium flowing inside WHR system 8 is too low, more external energy 36 must be supplied to WHR system 8 than is obtainable from it. This being the case, thermal energy 28 of the exhaust gas from combustion engine 24 needs to be greater than external energy 36 to allow mechanical energy 30 to be obtained from thermal energy 28 using WHR system 8.

Thermal energy 28 of exhaust gases from combustion engine 24 is primarily a function of the load state of combustion engine 24. Therefore, the present invention proposes to examine route 6 depicted in FIG. 1 and to estimate on which route sections 38 vehicle 2 exhibits an operating behavior that lends itself to use of WHR system 8. As an alternative or in addition, however, individual route sections 38 may also be detected as unsuitable for use of WHR system 8, whereupon the use of WHR system 8 is prohibited on these particular route sections 32.

The examination of route 6 may be performed adaptively, based on a detection as to whether this route 6 has been traveled on before. To do so, for example, a table in which the steering angle and the speed of the vehicle are compared to a traveled path and the corresponding load profile, for example, may be stored in a memory 40 of vehicle 2. If a comparison of the path of current route 6 across the steering angle and the speed correlates with the comparison stored in memory 40, then a previously traveled route may be inferred. In addition, driver profiles may be stored in memory 40, from which the driving behavior of the driver is able to be derived from the route.

As an alternative or in addition, the examination of route 6 is also able to be performed predictively by means of a navigation system 42 or a near-field sensor 44, based on the environmental and traffic data in connection with route 6. The driving behavior of the driver may be incorporated into the examination of route 6 in such a context as well. For example, traffic jams on route 6 are detectable with the aid of navigation system 42. Based on these detected traffic jams, the use of WHR system 8 could then be prohibited, because adequate operating conditions for an operation of WHR system 8 usually are present only above 70 km/h. As an alternative or in addition, the environment around vehicle 2 could be scanned by near-field sensor 44. Near-field sensor 44 may be a temperature sensor, which could be used to detect the outside temperature around vehicle 2, which likewise influences thermal energy 28 of the exhaust gas from combustion engine 24.

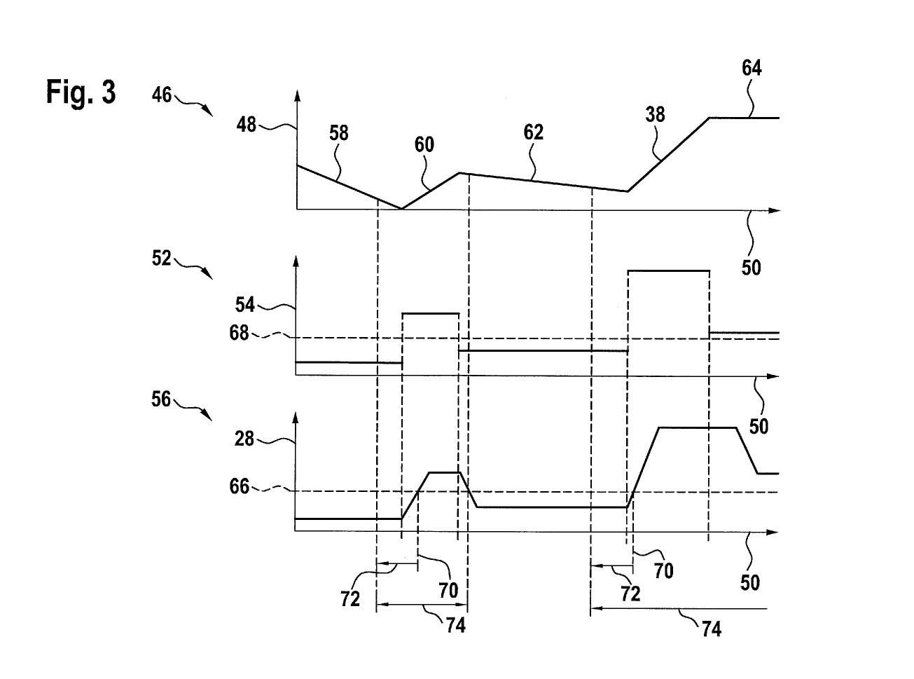

Reference is made to FIG. 3, which shows an example plan for the use of WHR system 8 from FIG. 2. Three diagrams are shown in FIG. 3; a first diagram 46 shows an altitude 48 of route 6 to be traveled by vehicle 4 of FIG. 1 across segment 50 of route 6; a second diagram 52 shows a load moment 54 of vehicle 4 over segment 50 on route 6; and a third diagram 56 shows thermal energy 28 of the exhaust gas from combustion engine 24 across segment 50 on route 6.

Route 6 shown in FIG. 1 and first diagram 46 of FIG. 3 may be subdivided into different route segments with regard to the altitude profile. In an initial first route segment 58, route 6 drops at a particular gradient across segment 50, whereas in a second route segment 60, route 6 becomes steeper across distance 50 at a particular incline. In a third route segment 62, route 6 drops again across segment 50 at a gradient which is smaller than the gradient of first route segment 58, whereas in a fourth route segment 38, which is to correspond to already mentioned route segment 38, route 6 rises across segment 50 at a gradient that is greater than the gradient of second route segment 60. In a fifth route segment 64, route 6 is meant to be level.

The profile of load moment 54 shown in second diagram 52 of FIG. 3 may be estimated on the basis of the segment profile of first diagram 46 of FIG. 3. However, still additional data such as an expected speed of vehicle 4 or an expected headwind of vehicle 4, which are detectable with the aid of navigation system 42 in the manner already described, may be incorporated into the profile of load moment 54. Moreover, to estimate load moment 54 across segment 50, vehicle data such as combustion engine data, the overall mass of the vehicle or a cw-value may be taken into account.

Expected thermal energy 28 of the exhaust gas from combustion engine 24 then results from the profile of load moment 54, but other data such as the already mentioned environment temperature around vehicle 4 may be considered in this context as well.

A threshold value 66 for thermal energy 28 of the exhaust gas of combustion engine 24, starting from which WHR system 8 may be deployed, has been indicated in third diagram 56 of FIG. 3.

To reach this threshold value 66, load moment 54 of combustion engine 24 must exceed a particular threshold value 68, which is shown in the second diagram of FIG. 3.

It is obvious from second diagram 52 of FIG. 3 that load moment 54 of combustion engine 24 in the example at hand will probably be too low for use of WHR system 8 on first route segment 58 and third route segment 62. Therefore, the use of WHR system 8 could initially be scheduled only on remaining route segments 60, 38, 64.

However, it is also clear that thermal energy 28 of the exhaust gas of combustion engine 24 does not rise abruptly but steadily with a rising load moment 54, which causes a corresponding delay (not referenced further) on second and fourth route segment 60, 38, until WHR system 8 may be used. On the other hand, WHR system 8 must be prepared for deployment. For example, this requires that a condensate present in a vapor path of condenser 18 be carefully blown out in order to avoid cavitation and thus damage. To ensure that WHR system 8 is also operative at corresponding starting points 70 of route 6 when thermal energy 28 of the exhaust gas exceeds threshold value 66, this development proposes to implement these preparatory measures on a preparatory segment 72 that lies before these starting points. Preparatory segment 72 has been sketched directly ahead of starting points 70 in the present development, but this need not necessarily be so. In these preparatory segments 72, the previously mentioned condensate outside the actual working medium circuit (e.g., in the generator housing) may be returned to the working medium circuit, for instance to condenser 18.

Since thermal energy 28 of the exhaust gas is likewise unable to change abruptly when load moment 54 is decreasing, just like with the increase in load moment 54, the drop of thermal energy 28 below threshold value 66 does not occur on second route segment 60, but as late as third route segment 62, which may also be taken into account. On the fifth route segment, thermal energy 28 will most likely no longer be below threshold value 66. This results in deployment segments 74 for WHR system 8.

Therefore, the electrical generator of vehicle 4 driven by combustion engine 24 may be replaced by the WHR system on these deployment segments 74.

Since the direct consumption of the electrical energy converted from mechanical energy 30 supplied by WHR system 8 is not ensured in many operating scenarios, the previously described scheduling may be expanded to the energy management, so that mechanical energy 30 supplied by WHR system 8 is able to be used in its entirety, if possible. For example, a battery 76 installed in vehicle 4 may absorb the electrical energy that is generated on the basis of mechanical energy 30 generated by WHR system 8, so that the generated electrical energy need not be used in electrical vehicle functions right away. As an alternative, battery 76 may absorb only excess electrical energy that is unable to be absorbed by the electrical vehicle functions.

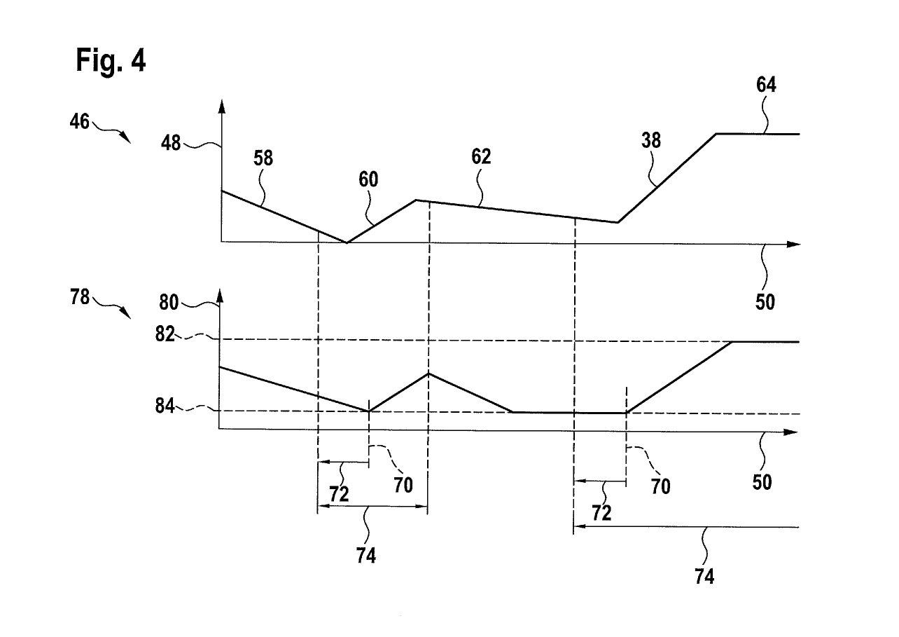

In addition, battery 76 could also be discharged well in advance of starting points 70 to ensure that it is actually able to absorb the excess electrical power and that WHR system 8 need not be operated at throttled capacity. This is to be explained in greater detail with the aid of FIG. 4, which also shows an expansion of the scheduling of FIG. 3 for the deployment of WHR system 8 of FIG. 2.

FIG. 4 once again shows first diagram 46 and a fourth diagram 78, in which a load state 80 of battery 76 of vehicle 4 from FIG. 1 is compared across segment 50 of route 6. Battery 76 may be charged between an end-of-charging voltage 82 and an end-of discharging voltage 84. As can be gathered from the fourth diagram of FIG. 4, the previously mentioned energy management may be set up so that it discharges battery 76 to end-of discharging voltage 84 until reaching a starting point 70. During operation, it is then possible to use the full capacity of battery 76, until end-of-charging voltage 82 has been reached, such as in fifth route segment 64, for example.

As an alternative or in addition, the prediction may be compared to the reality once individual route segment 60, 38, 64, which had been predicted to be suitable for deployment of WHR system 8, has actually been reached.

In addition, or within the framework of another, measures may be taken in the overall energy balancing to avoid that WHR system 8 is deactivated too frequently and too briefly, and to consider this in the operating strategy of WHR system 8. These measures could be, for instance:
a brief worsening of the efficiency of combustion engine 24 in order to increase thermal energy 30 of the exhaust gas for WHR system 8, for example by late injections, retarded ignition angle, other gear selection in automatic transmissions, etc.;
a brief reduction of the electrical energy consumers that ultimately utilize the thermal storage potential of the interior etc., e.g., seat heater, interior heating system, electrical climate-control system;
a brief lowering of the charge of battery 76;
a brief charge transfer of electrical stores into an affected onboard electrical system, e.g., for 12V-48V vehicle electrical system topologies which are connected via DC/DC converters; or
in hybrid drive train concepts having variable moment distribution of combustion engine 24 and electric motor, a brief increase in the portion of the combustion engine, whereas the portion of the electric motor is briefly reduced in order to increase the load of the combustion engine, and thus the exhaust gas energy.

If deployment segment 74 is too short, it is also possible to completely dispense with an activation of WHR system 8.

What is claimed is:

1. A method for planning a recovery of energy from an exhaust gas of a vehicle, comprising:
estimating an operating behavior of the vehicle on a route to be traveled by the vehicle; and
planning the recovery of energy from the exhaust gas of the vehicle based on a likelihood that the estimated operating behavior of the vehicle corresponds to an operating behavior that is suitable for the recovery.

2. The method as recited in claim 1, wherein the operating behavior suitable for the recovery of energy requires a state of the vehicle which satisfies at least one predefined condition for the recovery of energy from the exhaust gas of the vehicle.

3. The method as recited in claim 2, wherein the at least one predefined condition is a function of a predefined thermodynamic energy that the exhaust gas must have.

4. The method as recited in claim 1, further comprising:
planning a transfer of a system for the recovery of energy from the exhaust gas of the vehicle into an operative state, in a time before the estimated operating behavior corresponds to the suitable operating behavior, so that the system is ready to operate at the instant at which the estimated operating behavior corresponds to the suitable operating behavior.

5. The method as recited in claim 4, wherein the transfer of the system includes measures to overcome at least one of thermal inertia and mechanical inertia of the system.

6. The method as recited in claim 1, wherein the likelihood that the estimated operating behavior corresponds to the suitable operating behavior includes a likelihood whether the suitable operating behavior may be forced through the use of auxiliary units in the vehicle.

7. The method as recited in claim 6, wherein the likelihood of whether the suitable operating behavior is able to be forced through the use of auxiliary units in the vehicle includes a likelihood whether an energy of the exhaust gas of the vehicle is able to be increased by the auxiliary units.

8. The method as recited in claim 7, wherein the likelihood whether the suitable operating behavior is able to be forced through the use of auxiliary units in the vehicle includes a likelihood whether the suitable operating behavior is able to be adapted to the estimated operating behavior with the aid of auxiliary units in the vehicle.

9. The method as recited in claim 1, including the further step:
not allowing the recovery of energy from the exhaust gas of the vehicle if the likelihood that the estimated operating behavior corresponds to the suitable operating behavior drops below a predefined threshold value.

10. The method as recited in claim 1, including:
reading out the route to be traveled from a navigation device; and
estimating the operating behavior of the vehicle based on information about the route to be traveled supplied by the navigation device.

11. The method as recited in claim 1, including:
writing a travel log based on a route traveled by the vehicle, prior to traveling the route to be traveled; and
estimating the operating behavior of the vehicle on the route to be traveled by the vehicle based on the written travel log.

12. The method as recited in claim 1, including:
estimating the operating behavior of the vehicle based on a near-field sensor mounted on the vehicle.

13. The method as recited in claim 1, including:
recording a behavior of a driver of the vehicle; and
estimating the operating behavior of the vehicle based on the behavior of the driver of the vehicle.

14. A control device suitable for implementing a method for planning a recovery of energy from an exhaust gas of a vehicle, comprising:
estimating an operating behavior of the vehicle on a route to be traveled by the vehicle; and
planning the recovery of energy from the exhaust gas of the vehicle based on a likelihood that the estimated operating behavior of the vehicle corresponds to an operating behavior that is suitable for the recovery.
